(19) United States
(12) Patent Application Publication
(10) Pub. No.: US 2014/0207931 A1
(43) Pub. Date: Jul. 24, 2014

(54) DEVICE MANAGEMENT APPARATUS, DEVICE MANAGEMENT SYSTEM, AND DEVICE MANAGEMENT METHOD

(71) Applicant: Kaname KUROKAWA, Chiba (JP)

(72) Inventor: Kaname KUROKAWA, Chiba (JP)

(21) Appl. No.: 14/143,462

(22) Filed: Dec. 30, 2013

(30) Foreign Application Priority Data
Jan. 18, 2013 (JP) 2013-007428

(51) Int. Cl. H04L 12/24

(52) U.S. Cl. CPC H04L 41/14
USPC 709/223

(57) ABSTRACT

A device management apparatus includes a device information acquisition unit configured to acquire pieces of region information and pieces of model information from devices, respectively. Each piece of region information is about a region where the corresponding device is present. Each piece of model information indicates a model representing a type of the corresponding device. The apparatus also includes a first information generating unit configured to generate first information associating the region indicated by each piece of region information with the model present in the region; and a third information generating unit configured to generate third information associating the models included in the first information with device setting contents, respectively. Each device setting content is defined by second information and is determined in accordance with at least one of the region where the model corresponding to the each device setting content is present and another model present in the region.

### CROSS-REFERENCE TO RELATED APPLICATION

The present application claims priority to and incorporates by reference the entire contents of Japanese Patent Application No. 2013-007428 filed in Japan on Jan. 18, 2013.

### BACKGROUND OF THE INVENTION

1. Field of the Invention

The present invention relates to a device management apparatus, a device management system, and a device management method.

2. Description of the Related Art

With a recent increase in introduction of information technology (IT), IT devices (or information devices) such as personal computers (PCs), displays, printing devices, and image projecting devices have been introduced in various environments such as offices.

Such IT devices are managed as IT assets (fixed assets) in some cases. For example, Japanese Patent Application Laid-open No. 2005-208808 discloses a technique in which the locations of IT assets are managed by a management server using integrated circuit (IC) tags.

The conventional technique, however, has no idea of using the locations of the devices managed by a device management apparatus or the like for device setting. When a device setting content set to the device is generated in the conventional technique, a user needs to manually generate the device setting content because the device management apparatus cannot generate the device setting content. Such an approach, however, is impractical because the number of devices need to be managed is increasing.

Therefore, there is a need to provide a device management apparatus, a device management system, and a device management method that can reduce a cost for generating a device setting content.

### SUMMARY OF THE INVENTION

It is an object of the present invention to at least partially solve the problems in the conventional technology.

According to an embodiment, there is provided a device management apparatus that includes a device information acquisition unit configured to acquire pieces of region information and pieces of model information from a plurality of devices, respectively. Each piece of region information indicates information about a region where the corresponding device is present. Each piece of model information indicates a model representing a type of the corresponding device. The device management apparatus also includes a first information generating unit configured to generate first information associating the region indicated by the each piece of region information with the model present in the region; and a third information generating unit configured to generate third information associating the models included in the first information with device setting contents, respectively, by referring to second information. Each of the device setting contents is defined by the second information and being determined in accordance with at least one of the region where the model corresponding to the each of the device setting contents is present and another model present in the region.

According to another embodiment, there is provided a device management system that includes a device information acquisition unit configured to acquire pieces of region information and pieces of model information from a plurality of devices, respectively. Each piece of region information indicates information about a region where the corresponding device is present. Each piece of model information indicates a model representing a type of the corresponding device. The device management system also includes a first information generating unit configured to generate first information associating the region indicated by the each piece of region information with the model present in the region; a second information storage unit configured to store therein second information defining each of the device setting contents that is determined in accordance with at least one of the region where the model corresponding to the each of the device setting contents is present and another model present in the region; and a third information generating unit configured to generate third information associating the models included in the first information with the device setting contents, respectively, by referring to the second information.

According to still another embodiment, there is provided a device management method that includes acquiring pieces of region information and pieces of model information from a plurality of devices, respectively, each piece of region information indicating information about a region where the corresponding device is present, each piece of model information indicating a model representing a type of the corresponding device; generating first information associating the region indicated by the each piece of region information with the model present in the region; and generating third information associating the models included in the first information with device setting contents, respectively, by referring to second information, each of the device setting contents being defined by the second information and being determined in accordance with at least one of the region where the model corresponding to the each of the device setting contents is present and another model present in the region.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an exemplary structure of a device management system of an embodiment of the present invention;

FIG. 2 is a block diagram illustrating an exemplary structure of a device management apparatus of the embodiment;

FIG. 3 is a table illustrating an example of a condition table of the embodiment;

FIG. 4 is a table illustrating an example of a writer table of the embodiment;

FIG. 5 is a table illustrating an example of a device table of the embodiment;

FIG. 6 is a table illustrating an example of a region table of the embodiment;

FIG. 7 is a table illustrating an example of a device setting table of the embodiment;

FIG. 8 is a block diagram illustrating an exemplary structure of a device of the embodiment;

FIG. 9 is a sequence diagram illustrating an example of processing performed by the device management system in the embodiment;

FIG. 10 is a flowchart illustrating an example of processing performed by the device management system in the embodiment to generate the device setting table;

FIG. 11 is a table illustrating an example of the condition table of a first modification;

FIG. 12 is a table illustrating an example of the region table of the first modification;

FIG. 13 is a table illustrating an example of the device setting table of the first modification; and

FIG. 14 is a block diagram illustrating an exemplary hardware structure of the device management apparatus and the device of the embodiment and the modifications.

### DETAILED DESCRIPTION OF THE PREFERRED EMBODIMENTS

Embodiments of a device management apparatus, a device management system, and a device management method according to the invention are described in detail below with reference to the accompanying drawings.

The following describes a structure of a device management system of an embodiment.

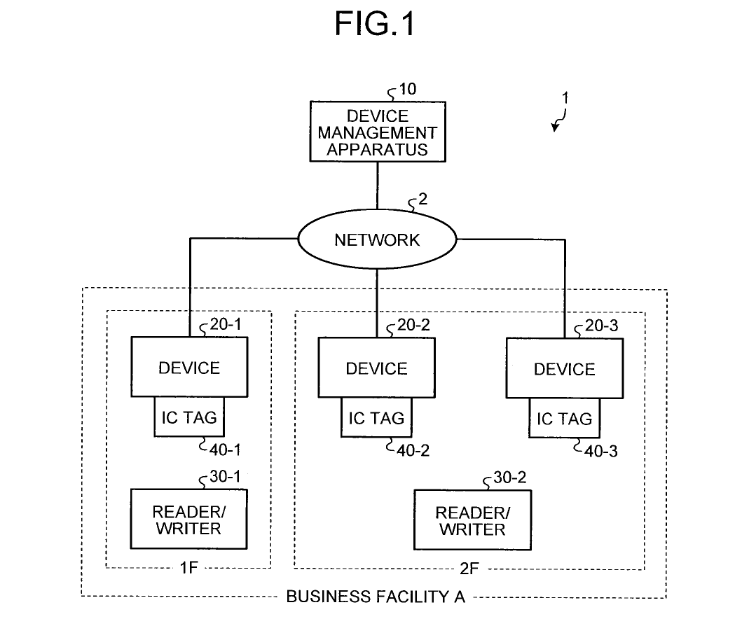

FIG. 1 is a block diagram illustrating an exemplary structure of a device management system 1 of the embodiment. As illustrated in FIG. 1, the device management system 1 includes a device management apparatus 10, devices 20-1 to 20-3, and reader/writers 30-1 and 30-2. The device management apparatus 10 and the devices 20-1 to 20-3 are coupled through a network 2. The network 2 can be achieved with the Internet or a local area network (LAN), for example.

In the embodiment, the device management apparatus 10 is provided in a service center of a service providing company that provides a device management service. The devices 20-1 to 20-3 and the reader/writers 30-1 and 30-2 are provided at a service site. The site where the device management apparatus 10 is provided is not limited to the service center and may be the service site, for example. A service site means an area where management target devices are provided. For example, a service site can be a business facility or an office of a company receiving the device management service.

In the embodiment, the device 20-1 and the reader/writer 30-1 are disposed on the first floor of a business facility A, which is a service site, while the devices 20-2 and 20-3 and the reader/writer 30-2 are disposed on the second floor of the business facility A. The reader/writers 30-1 and 30-2 (examples of a writing device) are fixedly disposed at the entrances on the first and the second floors of the business facility A, respectively, as gates, for example. The manner of disposition thereof, however, is not limited to this example. The reader/writers may be disposed at the entrances of respective rooms such as offices, conference rooms, and laboratories on the respective floors. Other units than gates may be used as the reader/writers.

The device management apparatus 10 manages the devices 20-1 to 20-3 and can be achieved with a personal computer (PC) on which a device management program, which is described later, is installed, for example. FIG. 1 exemplarily illustrates the devices 20-1 to 20-3 as the devices managed by the device management apparatus 10. However, the devices are not limited to those described above.

The devices 20-1 to 20-3 may be the devices connectable to the network 2. Examples of the devices 20-1 to 20-3 include information processing devices such as PCs and tablets, image forming devices such as printing devices, copying machines, multifunction peripherals (MFPs), scanners, and facsimiles, and various electronic devices such as projectors, cameras, air conditioners, refrigerators, fluorescent lamps, automatic vending machines, and handheld terminals. MFPs have at least two functions out of copying, printing, scanning, and facsimile functions. In the embodiment, an example is described in which the device 20-1 is a tablet, the device 20-2 is a PC, and the device 20-3 is an MFP. The devices 20-1 to 20-3, however, are not limited to this example.

The devices 20-1 to 20-3 are provided with respective integrated circuit (IC) tags 40-1 to 40-3 (examples of a storage device). A reader/writer ID (an example of writer identifying information identifying the writer) of the reader/writer 30-1 fixedly disposed on the first floor of the business facility A is written into the IC tag 40-1 because the device 20-1 provided with the IC tag 40-1 is disposed on the first floor. Likewise, the reader/writer ID of the reader/writer 30-2 fixedly disposed on the second floor of the business facility A is written into the IC tags 40-2 and 40-3 because the devices 20-2 and 20-3 provided with the IC tags 40-2 and 40-3, respectively, are disposed on the second floor.

In the following description, the devices 20-1 to 20-3 may be simply referred to as a device 20 when they do not need to be distinguished from each other; the reader/writers 30-1 and 30-2 may be simply referred to as a reader/writer 30 when they do not need to be distinguished from each other; and the IC tags 40-1 to 40-3 may be simply referred to as an IC tag 40 when they do not need to be distinguished from each other.

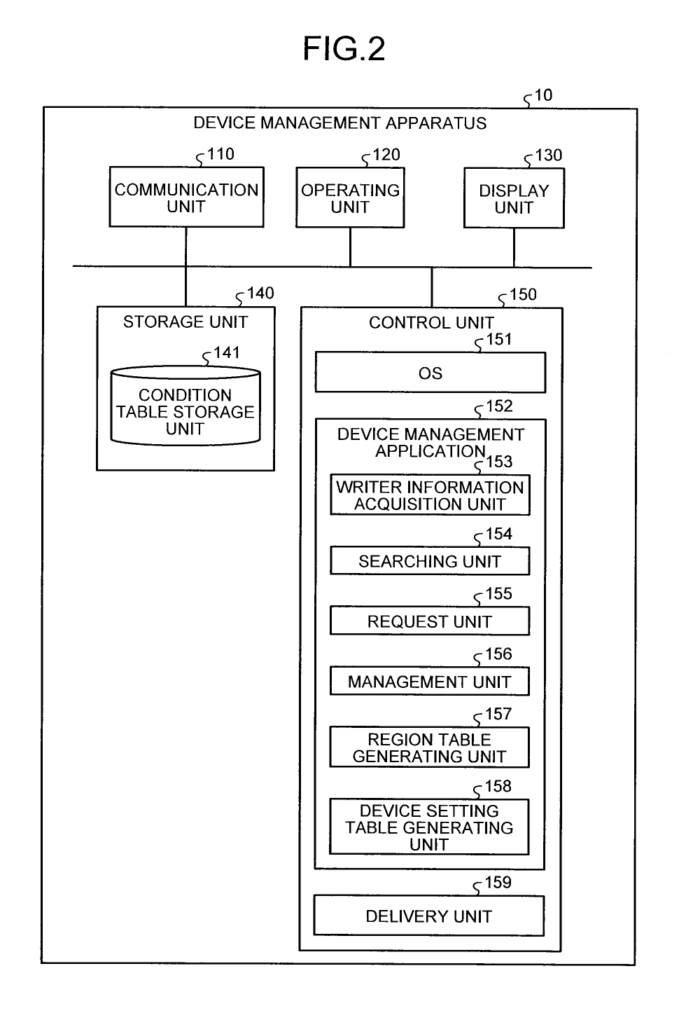

FIG. 2 is a block diagram illustrating an exemplary structure of the device management apparatus 10 of the embodiment. As illustrated in FIG. 2, the device management apparatus 10 includes a communication unit 110, an operating unit 120, a display unit 130, a storage unit 140, and a control unit 150.

The communication unit 110 communicates with an external device such as the device 20 through the network 2 and can be achieved with a network interface card (NIC), for example.

The operating unit 120 is used for various types of operation input, and can be achieved with an input device, such as a keyboard, a mouse, a touch pad, or a touch panel.

The display unit 130 displays various screens, and can be achieved with a display device, such as a liquid crystal display or a touch panel display.

The storage unit 140 stores therein various computer programs such as an operating system (OS) program and the device management program executed by the device management apparatus 10, and various types of data, such as of the device control program, used for various types of processing performed by the device management apparatus 10. The storage unit 140 can be achieved by at least one of storage devices capable of magnetically, optically, or electrically storing data, such as a hard disk drive (HDD), a solid state drive (SSD), a memory card, an optical disk, a read only memory (ROM), and a random access memory (RAM).

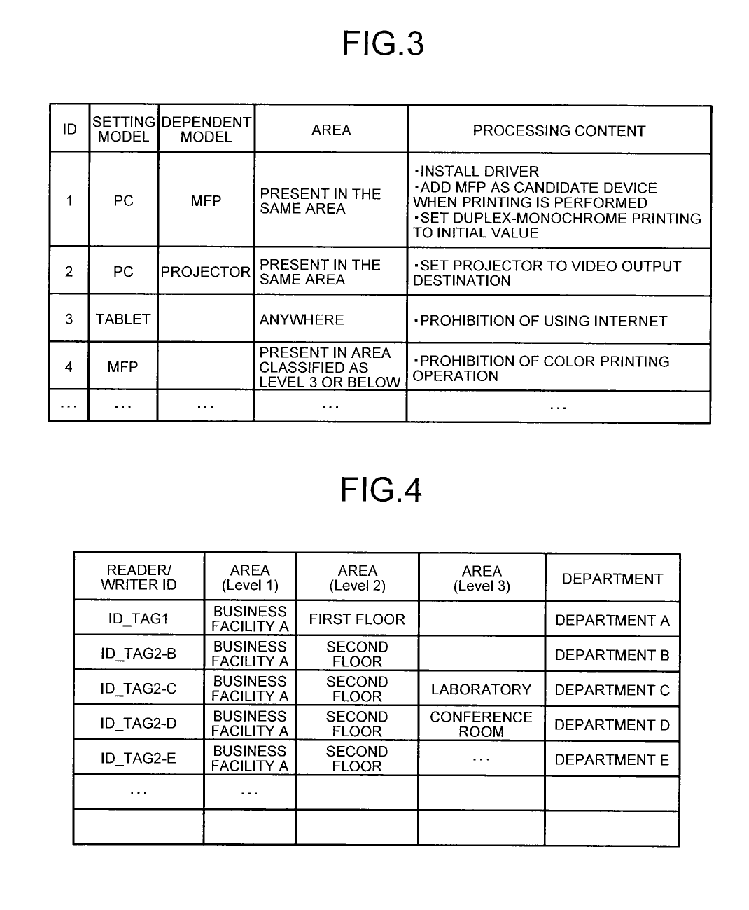

The storage unit 140 includes a condition table storage unit 141 (an example of a second information storage unit). The condition table storage unit 141 stores therein a condition table (an example of second information) defining, for each model, a device setting content determined in accordance with at least one of a region where the model is present and the other model present in the region. FIG. 3 is a table illustrating an example of the condition table of the embodiment. In the example illustrated in FIG. 3, the condition table stores therein an ID, a setting model, a dependent model, an area, and a processing content in association with each other. In the example illustrated in FIG. 3, the setting model corresponds to the model, the area corresponds to the region, the dependent model corresponds to the other model, and the processing content corresponds to the device setting content. The items stored in the condition table, however, are not limited to those in the example. The dependent model is the model that is dependent on the setting model. There may be a case where no dependent model is present. The area indicates the area where the setting model is present. When the dependent model is also present, the indicated area is where both the setting model and the dependent model are present. In the embodiment, the processing content is defined for each setting model in a format of a file, for example.

For example, in the condition table illustrated in FIG. 3, when the PC serving as the setting model and the MFP serving as the dependent model are present in the same area, the following contents are defined as the processing contents for the PC: the driver for the MFP is installed, the MFP is added as a candidate device for printing when printing is instructed from the PC, and duplex-monochrome printing is set as an initial value when printing is instructed from the PC.

For another example, in the condition table illustrated in FIG. 3, when the setting model is the MFP and the MFP is present in the area classified as level 3 or below, prohibition of color printing operation is defined as the processing content for the MFP. The levels of the area are described later.

The control unit 150 controls each unit of the device management apparatus 10, and can be achieved by a control device such as a central processing unit (CPU). The control unit 150 includes an OS 151, a device management application 152, and a delivery unit 159. The control unit 150 implements the OS 151 and the device management application 152 as software by activating (executing) the OS program and the device management program stored in the storage unit 140.

The OS 151 controls each unit (in detail, hardware and software of the device management apparatus 10) of the device management apparatus 10 and can be achieved with basic software such as Windows (registered trademark) or UNIX (registered trademark), for example.

The device management application 152 manages the management target devices using a general-purpose protocol such as a simple network management protocol (SNMP) typically used in device management. The device management application 152 includes a writer information acquisition unit 153, a searching unit 154, a request unit 155, a management unit 156, a region table generating unit 157, and a device setting table generating unit 158.

The writer information acquisition unit 153 acquires, from each of the reader/writers 30, region identifying information identifying the region where the reader/writer 30 is present and the reader/writer ID identifying the reader/writer 30, through the OS 151. The writer information acquisition unit 153 generates a writer table in which the acquired region identifying information and reader/writer IDs of the respective reader/writers 30 are associated with each other, and stores the generated writer table in the storage unit 140.

FIG. 4 is a table illustrating an example of the writer table of the embodiment. In the example illustrated in FIG. 4, the writer table includes writer information in which the reader/writer ID, an area (level 1), an area (level 2), an area (level 3), and a department are associated with each other. In the example illustrated in FIG. 4, the area (level 1), the area (level 2), the area (level 3), and the department are the region identifying information. The items included in the region identifying information are not limited to those in the example.

In the embodiment, the area where the reader/writer 30 is present is identified as a hierarchy with levels. In the example illustrated in FIG. 4, the area where the reader/writer 30 is present is identified as a three-level hierarchy with level 1 to level 3. The area of level 1 identifies the business facility, the area of level 2 identifies the floor, and the area of level 3 identifies the room. For example, the reader/writer 30 having the reader/writer ID of “ID_TAG2-B” is identified as being present in an area on the second floor of the business facility A on the basis of the information that the area of level 1 is the business facility A and the area of level 2 is the second floor.

In the embodiment, the reader/writer ID of the reader/writer 30-1 is “ID_TAG1” while the reader/writer ID of the reader/writer 30-2 is “ID_TAG2-B”. The reader/writer IDs of the respective reader/writers 30, however, are not limited to this example.

The searching unit 154 searches for the device 20. The searching unit 154, for example, transmits a request such as an SNMP or a packet internet groper (PING) request to the Internet Protocol (IP) address of a searching target through the OS 151 and searches for a new device 20 (not included in the management target).

The request unit 155 requests the delivery unit 159 to deliver (transmit) a device control program to the new device 20 and notifies the delivery unit 159 of an asset number to be set to the device 20 when the device 20 is searched by the searching unit 154.

When requested to deliver the device control program by the device management application 152, the delivery unit 159 acquires the device control program from the storage unit 140, sets the asset number notified by the device management application 152, and delivers (transmits) the device control program to the device 20 in the request, through the OS 151.

The management unit 156 (an example of a device information acquisition unit) manages the management target device 20. Specifically, the management unit 156 acquires, from each of the management target devices 20, region information about the region where the device 20 is present and model information indicating the model representing a type of the device 20.

For example, the management unit 156 acquires, from the device 20 to which the device control program is delivered by the delivery unit 159, device information including the asset number, the device name, the serial number, the model name, the registered date, and the administrator's information of the device 20 through the OS 151. The model name included in the device information corresponds to the model information. The model information, however, is not limited to the model name. The management unit 156 then adds the acquired device information to a device table stored in the storage unit 140. As a result, the device information of the device 20 is added to the device table, resulting in the device 20 being newly (registered) included in the management target devices of the device management apparatus 10 (the device management application 152). The management unit 156 controls the management target devices 20 through the network 2 by periodically communicating with the management target devices 20.

The management unit 156 acquires, as the region information from each of the management target devices 20, the reader/writer ID written into the IC tag 40 provided to the device 20. Specifically, the management unit 156 acquires, from the management target device 20 through the OS 151, the reader/writer ID written into (stored in) the IC tag 40, the asset number of the device 20, and the IC tag ID of the IC tag 40. The management unit 156 then adds the acquired reader/writer ID and IC tag ID to the device information including the acquired asset number in the device table.

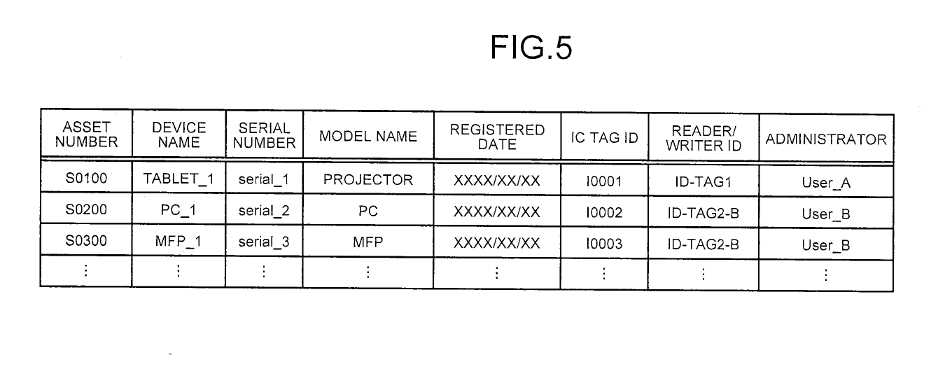

FIG. 5 is a table illustrating an example of the device table of the embodiment. In the example illustrated in FIG. 5, the device table includes the device information in which the asset number, the device name, the serial number, the model name, the registered date, the IC tag ID, the reader/writer ID, and the administrator's information are associated with each other. The asset number, the device name, the serial number, the model name, the registered date, and the administrator's information are registered (stored) when the management unit 156 sets the device 20 as the management target of the device management apparatus 10 (the device management application 152), and thereafter the IC tag ID and the reader/writer ID are registered (stored).

In the embodiment, the asset number of the device 20-1 is “S0100”, the asset number of the device 20-2 is “S0200”, and the asset number of the device 20-3 is “S0300”. The IC tag ID of the IC tag 40-1 is “I0001”, the IC tag ID of the IC tag 40-2 is “I0002”, and the IC tag ID of the IC tag 40-3 is “I0003”. The asset number and the IC tag ID, however, are not limited to those described above.

The region table generating unit 157 (an example of a first information generating unit) generates a region table (an example of first information) in which each region indicated by the region information acquired by the management unit 156 and the model present in the region are associated with each other. In the embodiment, the region table generating unit 157 uses the region identified by the region identifying information acquired by the writer information acquisition unit 153 and the reader/writer ID acquired by the management unit 156 as the region indicated by the region information. The region indicated by the region information, however, is not limited to those described above.

Specifically, the region table generating unit 157 refers to the writer table and the device table stored in the storage unit 140, generates the region table in which the region identified by the region identifying information, the reader/writer ID of the reader/writer 30 present in the region, and the model name of the device having the reader/writer ID are associated with each other, and stores the generated region table in the storage unit 140.

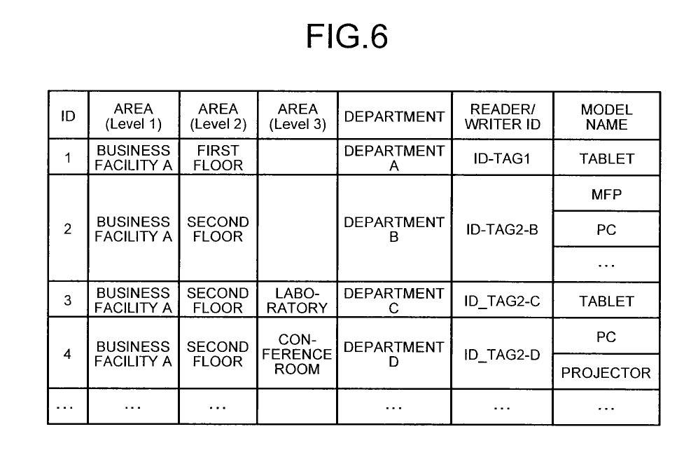

FIG. 6 is a table illustrating an example of the region table of the embodiment. In the example illustrated in FIG. 6, the region table includes information in which the ID, the area (level 1), the area (level 2), the area (level 3), the department, the reader/writer ID, and the model name are associated with each other. For example, ID_TAG1 is associated with the tablet, which is the model name of the device 20-1, because the device 20-1 is present in the area where the reader/writer 30-1 having the reader/writer ID of “ID_TG1” is present. For another example, ID_TAG2-B is associate with the PC, which is the model name of the device 20-2, and the MFP, which is the model name of the device 20-3, because the devices 20-2 and 20-3 are present in the area where the reader/writer 30-2 having the reader/writer ID of “ID_TAG2-B” is present.

The device setting table generating unit 158 (an example of a third information generating unit) refers to the condition table stored in the condition table storage unit 141, generates a device setting table (an example of third information) in which each model in the region table stored in the storage unit 140 is associated with the device setting content for the model, and stores the generated device setting table in the storage unit 140. Specifically, the device setting table generating unit 158 refers to the condition table and generates the device setting table by adding the device setting contents to the respective models in the region table.

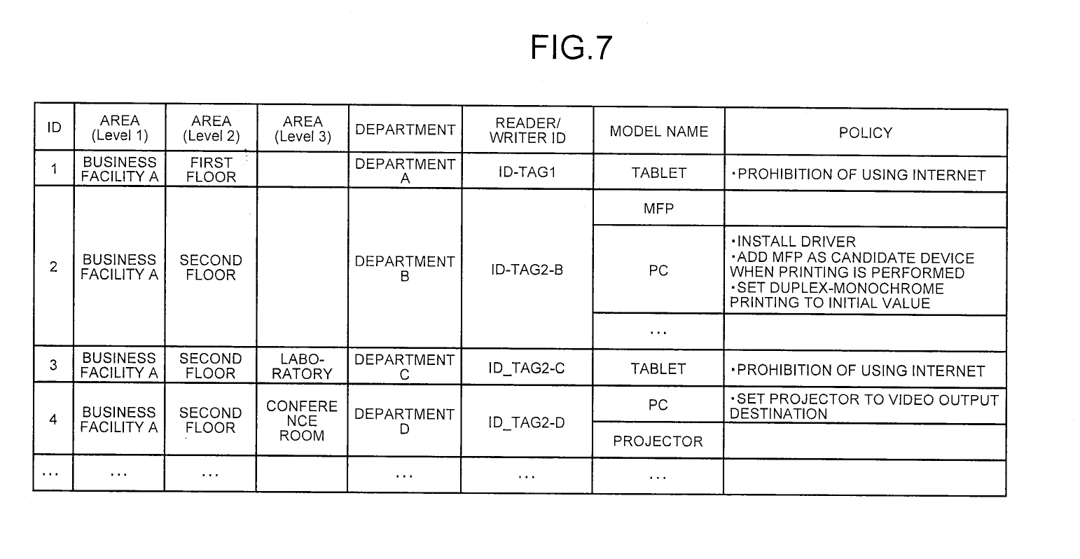

FIG. 7 is a table illustrating an example of the device setting table of the embodiment. In the example illustrated in FIG. 7, the device setting table includes information in which the ID, the area (level 1), the area (level 2), the area (level 3), the department, the reader/writer ID, the model name, and a policy are associated with each other. In the example illustrated in FIG. 7, the policy corresponds to the device setting content. The device setting content, however, is not limited to the policy.

For example, because the PC and the MFP are associated with ID_TAG2-B, the condition is satisfied that “the PC serving as the setting model and the MFP serving as the dependent model are present in the same area” in the condition table illustrated in FIG. 3. Thus, the PC associated with ID_TAG2-B is associated with the following policies (processing contents in the condition table illustrated in FIG. 3): the driver for the MFP is installed, the MFP is added as a candidate device for printing when printing is instructed from the PC, and duplex-monochrome printing is set as an initial value when printing is instructed from the PC.

The device management application 152 applies the corresponding policy to the device 20. For example, the device management application 152 refers to the device setting table, acquires the policies that the driver for the MFP is installed, the MFP is added as a candidate device for printing when printing is instructed from the PC, and duplex-monochrome printing is set as an initial value when printing is instructed from the PC, and transmits the acquired policies to the device 20-2 through the OS 151.

The device management apparatus 10 does not necessarily include all of the units described above as mandatory units, and some of the units may be omitted.

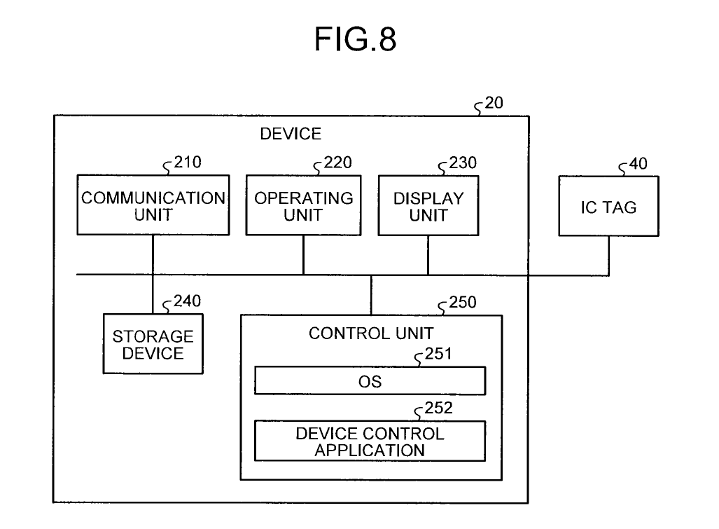

FIG. 8 is a block diagram illustrating an exemplary structure of the device 20 of the embodiment. As illustrated in FIG. 8, the device 20 includes a communication unit 210, an operating unit 220, a display unit 230, a storage unit 240, and a control unit 250. The device 20 is provided with the IC tag 40. In the embodiment, the IC tag 40 is attached to the device 20 through an external interface such as a universal serial bus (USB), for example. The IC tag 40 is not limited to being externally attached to the device 20. The IC tag 40 may be built in the device 20.

The communication unit 210 communicates with an external apparatus such as the device management apparatus 10 through the network 2 and can be achieved with a NIC, for example.

The operating unit 220 is used for various types of operation input, and can be achieved with an input device, such as a keyboard, a mouse, a touch pad, or a touch panel.

The display unit 230 displays various screens, and can be achieved with a display device, such as a liquid crystal display or a touch panel display.

The storage unit 240 stores therein various programs such as an OS program and a device control program executed by the device 20, and data used for various types of processing performed by the device 20 such as the asset number, the device name, the serial number, the model name, the registered date, and the administrator's information of the device 20. The asset number and the registered date of the device 20 are set by the device management apparatus 10. Specifically, the device control program is delivered (downloaded) to the device 20 from the device management apparatus 10 and installed in the storage unit 240, so that the asset number and the registered date of the device 20 are stored in the storage unit 240. Items such as the device name, the serial number, the model name, and the administrator's information of the device 20 are preliminarily stored in the storage unit 240.

The storage unit 240 can be achieved by at least one of the storage devices capable of magnetically, optically, or electrically storing data, such as an HDD, an SSD, a memory card, an optical disk, a ROM, and a RAM, for example.

The control unit 250 controls each unit of the device 20, and can be achieved by the control device such as a CPU. The control unit 250 includes an OS 251 and a device control application 252. The control unit 250 implements the OS 251 and the device control application 252 as software by activating (executing) the OS program and the device control program stored in the storage unit 240.

The OS 251 controls each unit (in detail, hardware and software of the device 20) of the device 20 and can be achieved with basic software such as Windows or UNIX, for example.

The device control application 252 manages the device 20. The device control application 252 acquires the reader/writer ID and the IC tag ID from the IC tag 40 and the asset number from the storage unit 240, and transmits them to the device management apparatus 10 through the OS 251. The device control application 252 receives the policy for the device 20 from the device management apparatus 10 through the OS 251, and performs control on the basis of the received policy.

For example, when the device 20 is the device 20-2, the device control application 252 receives the policies that the driver for the MFP is installed, the MFP is added as a candidate device for printing when printing is instructed from the PC, and duplex-monochrome printing is set as an initial value when printing is instructed from the PC. The device control application 252 thus installs the driver for the MFP (the device 20-3), adds the MFP (the device 20-3) as the candidate device for printing when printing is performed, and sets duplex-monochrome printing as the initial value when printing is performed.

The device 20 does not necessarily include all of the units described above as mandatory units, and some of the units may be omitted.

The following describes operation of the device management system of the embodiment. The operation of the device management system 1 is described using the device 20-2 as an example. The other devices 20 also operate in the same manner as described below.

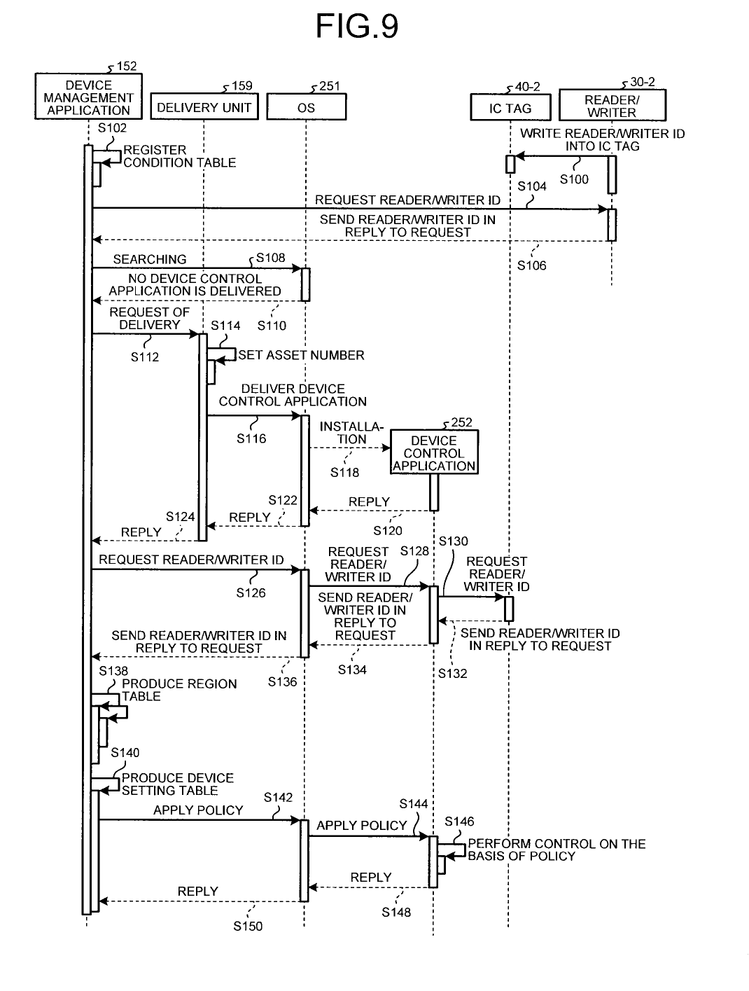

FIG. 9 is a sequence diagram illustrating an example of processing performed by the device management system 1 in the embodiment.

When the device 20-2 provided with the IC tag 40-2 passes through the reader/writer 30-2, the reader/writer 30-2 detects the IC tag 40-2 provided to the device 20-2 and writes its own reader/writer ID into the detected IC tag 40-2 (step S100).

The processing illustrated at step S100 may be performed at any timing. In the embodiment, the processing is performed at the timing when the device 20-2 passes through the reader/writer 30-2 (gate) fixedly disposed at a doorway on the second floor of the business facility A after the device 20-2 is brought in the second floor of the business facility A, where the reader/writer 30-2 is disposed.

The condition table is registered in the condition table storage unit 141 in accordance with input from the operating unit 120 (step S102).

The writer information acquisition unit 153 in the device management application 152 of the device management apparatus 10 requests the region identifying information and the reader/writer ID from each of the reader/writers 30 (step S104).

Each reader/writer 30 sends its own region identifying information and reader/writer ID to the device management application 152 in reply to the request (step S106).

The writer information acquisition unit 153 generates the writer table in which the acquired region identifying information and reader/writer IDs of the respective reader/writers 30 are associated with each other, and stores the generated writer table in the storage unit 140.

The searching unit 154 in the device management application 152 of the device management apparatus 10 transmits a request to the IP address of a searching target, and searches for a new device 20 (step S108). Here, the IP address of the searching target is the IP address of the device 20-2 disposed on the second floor of the business facility A.

The OS 251 of the device 20-2 sends a reply to the device management application 152, indicating that no device control application is delivered, in reply to the request (step S110).

On the basis of the search on the device 20-2 by the searching unit 154, the request unit 155 in the device management application 152 requests the delivery unit 159 to deliver the device control program to the device 20-2 and notifies the delivery unit 159 of the asset number set to the device 20-2 (step S112).

When requested to deliver the device control program by the device management application 152, the delivery unit 159 acquires the device control program from the storage unit 140, sets the asset number notified by the device management application 152 (step S114), and delivers the device control program to the device 20-2 (step S116).

When the device control program is delivered from the device management apparatus 10, the OS 251 of the device 20-2 installs the device control program in the storage unit 240 (step S118). As a result, the asset number and the registered date of the device 20-2 are stored in the storage unit 240. The OS 251 then activates (executes) the device control program stored in the storage unit 240, thereby implementing the device control application 252 as software.

The device control application 252 of the device 20-2 acquires the asset number, the device name, the serial number, the model name, and the registered date of the device 20-2 from the storage unit 240 and notifies the device management application 152 of the acquired information through the OS 251 in reply to the delivery of the device control program (step S120 to step S124).

The management unit 156 in the device management application 152 acquires the asset number, the device name, the serial number, the model name, and the registered date from the device control application 252 and adds them to the device table stored in the storage unit 140 as the device information.

The management unit 156 in the device management application 152 then requests the reader/writer ID from the OS 251 (step S126).

When the reader/writer ID is requested through the OS 251 (step S128), the device control application 252 requests the reader/writer ID and the IC tag ID from the IC tag 40-2 (step S130).

The IC tag 40-2 sends the reader/writer ID written therein and its own IC tag ID to the device control application 252 in reply to the request (step S132).

The device control application 252 acquires its own asset number from the storage unit 240 and sends the acquired asset number to the device management application 152 through the OS 251 together with the reader/writer ID and the IC tag ID received from the IC tag 40-2 in reply to the request (step S134 and step S136).

The management unit 156 in the device management application 152 acquires the asset number, the reader/writer ID, and the IC tag ID from the device control application 252, and adds the acquired reader/writer ID and IC tag ID to the device information having the acquired asset number in the device table.

The region table generating unit 157 in the device management application 152 refers to the writer table and the device table stored in the storage unit 140, generates the region table in which the region identified by the region identifying information, the reader/writer ID of the reader/writer 30 present in the region, and the model name of the device having the reader/writer ID are associated with each other, and stores the generated region table in the storage unit 140 (step S138).

The device setting table generating unit 158 refers to the condition table stored in the condition table storage unit 141 and generates the device setting table by adding the device setting contents to the respective models in the region table stored in the storage unit 140 as the policies (step S140).

The device management application 152 then refers to the device setting table, acquires the policy for the device 20-2, and transmits the acquired policy to the OS 251 (step S142).

When the policy is received through the OS 251 (step S144), the device control application 252 performs control on the basis of the received policy (step S146).

The device control application 252 then sends a reply that the policy is applied to the device 20-2 to the device management application 152 through the OS 251 (step S148 and step S150).

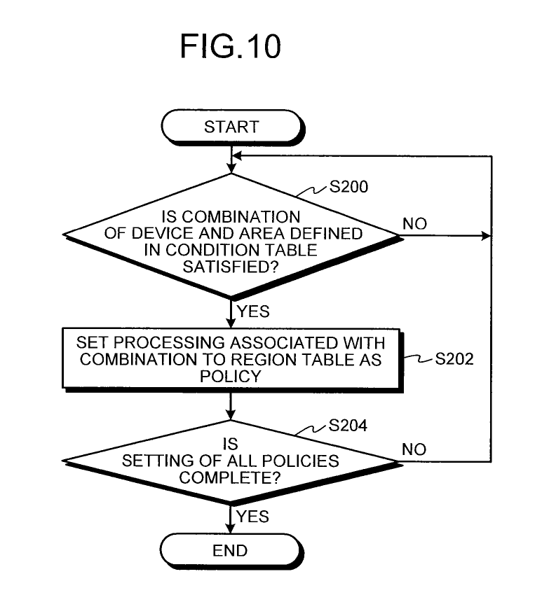

FIG. 10 is a flowchart illustrating an example of processing performed by the device management system 1 in the embodiment to generate the device setting table.

The device setting table generating unit 158 refers to the condition table stored in the condition table storage unit 141 and determines whether the model associated with the reader/writer ID in the region table satisfies the combination of the model (the setting model and the dependent model) and the area defined in the condition table (step S200). If it is determined that the model associated with the reader/writer ID in the region table does not satisfy the combination (No at step S200), the processing returns to step S200.

If it is determined that the model associated with the reader/writer ID in the region table satisfies the combination (Yes at step S200), the device setting table generating unit 158 associates the processing content associated with the combination in the condition table with the model in the region table as the policy (step S202).

The device setting table generating unit 158 then determines whether the respective corresponding policies are set to all of the models in the region table (step S204) and ends the processing if the setting of the policies is complete (Yes at step S204). If the setting of the policies is not yet complete (No at step S204), the processing returns to step S200.

As described above, in the embodiment, the device management apparatus manages the locations of the devices and the conditions of the device setting contents, thereby making it possible to generate the device setting contents in accordance with the locations of the devices. The embodiment thus can automatically generate the device setting contents applied to the devices, thereby making it possible to eliminate user's manual operation. As a result, costs (personal costs, monetary costs, and time costs) of generating the device setting contents can be reduced.

Modifications

The invention is not limited to the embodiment described above and various modifications can be made.

First Modification

The embodiment describes an example in which the device setting content is determined in accordance with the region where the model is present and the other model present in the region. The device setting content may be determined with further consideration of a security level (an example of a degree of security), for example.

In this case, the condition table may define, for each model, the device setting content determined in accordance with at least one of the region where the model is present, the other model present in the region, and the security level of the other model.

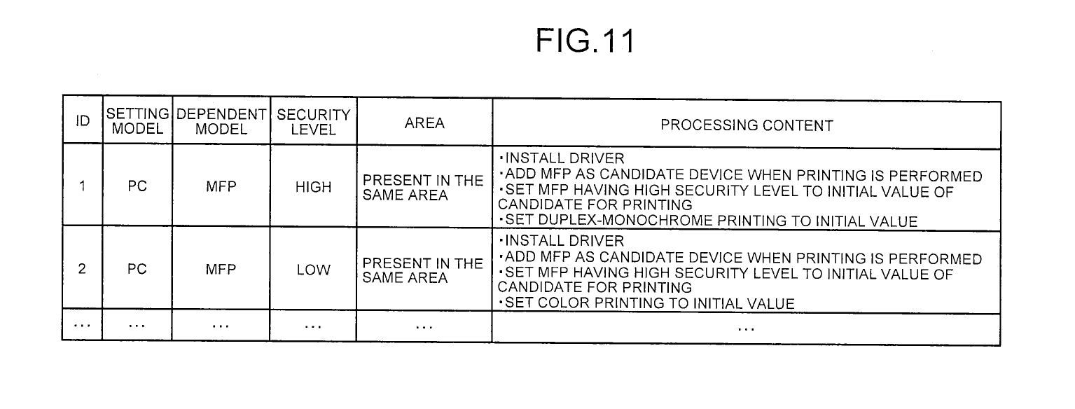

For example, in the condition table illustrated in FIG. 11, the processing content for the PC serving as the setting model differs depending on whether the security level of the MFP serving as the dependent model is high or low. Specifically, when the security level of the MFP serving as the dependent model is high, the duplex-monochrome printing is set to the initial value, while when the security level of the MFP serving as the dependent model is low, color printing is set to the initial value.

The device 20 may store its own security level in the storage unit 240, for example. The management unit 156 may acquire security information indicating the security level of the device 20 when acquiring the region information from each of the management target devices 20.

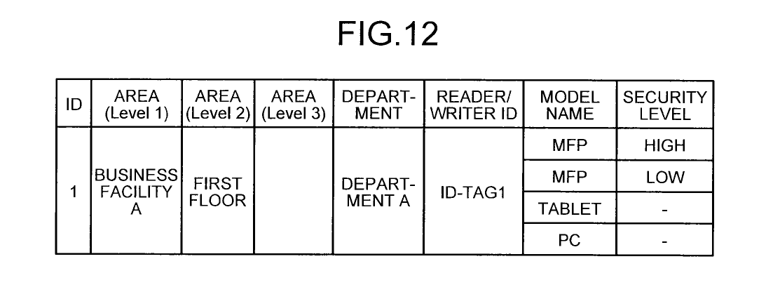

The region table generating unit 157 may generate the region table in which, each region indicated by the region information is associated with the model present in the region in accordance with the security level of the device. For example, the region table illustrated in FIG. 12 associates the reader/writer ID with the models in accordance with their security levels.

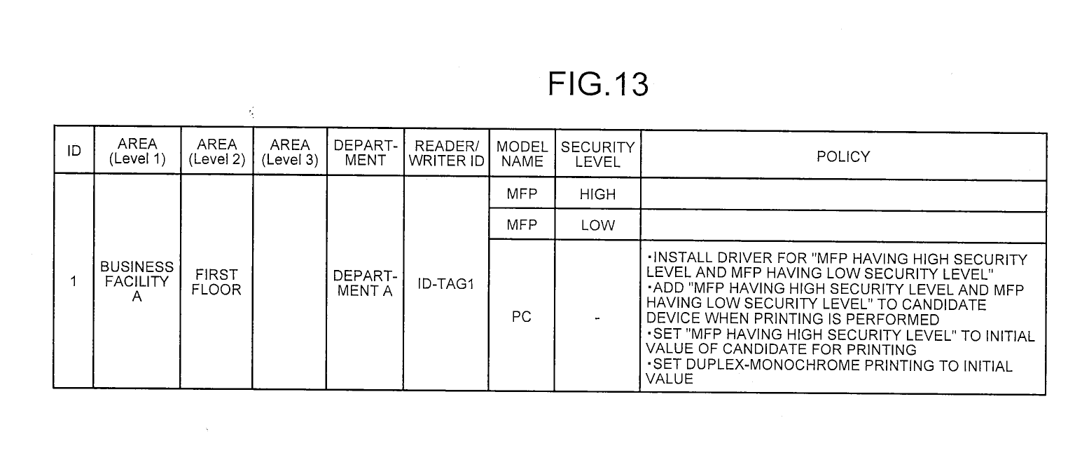

The device setting table generating unit 158 may generate the device setting table by adding the device setting contents to the respective models in the region table. For example, the device setting table illustrated in FIG. 13, the policies are associated with the models by security levels.

The first modification can automatically generate more detailed device setting contents in which the security levels of the devices are further considered, thereby making it possible to further reduce the costs of generating the device setting contents.

Second Modification

In the embodiment, the device management apparatus 10 delivers the device control program. The processing performed by the delivery unit 159 of the device management apparatus 10 may be performed by a server provided separately from the device management apparatus 10.

Third Modification

The embodiment describes an example in which the device management apparatus 10 includes the condition table storage unit 141. The condition table storage unit 141 may be provided outside the device management apparatus 10 (e.g., on a cloud, i.e., a computer network) and the device setting table generating unit 158 may acquire the condition table from the externally provided condition table storage unit 141 and refer to the condition table.

Hardware Structure

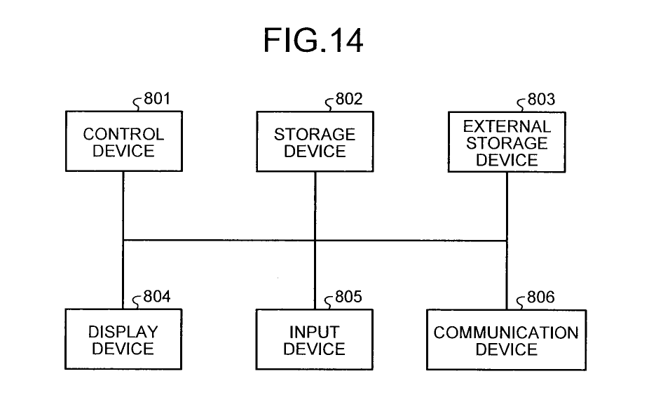

FIG. 14 is a block diagram illustrating an exemplary hardware structure of the device management apparatus 10 and the device 20 of the embodiment and the modifications. As illustrated in FIG. 14, the device management apparatus 10 and the device 20 of the embodiment and the modifications include a control device 801 such as a CPU, a storage device 802 such as a ROM or a RAM, an external storage device 803 such as an HDD or an SSD, a display device 804 such as a display, an input device 805 such as a mouse or a keyboard, and a communication device 806 such as a NIC, and can be achieved by a hardware structure using a typical computer. When the device 20 is an image forming device, a printing device such as a plotter is additionally included. When the device 20 is a projector, a projecting device such as a projection lens is additionally included.

The device management program executed by the device management apparatus 10 and the device control program executed by the device 20 in the embodiment and the modifications are stored in a computer-readable storage medium as a file in an installable or executable format, and provided. Examples of the computer-readable storage medium include a CD-ROM, a CD-R, a memory card, a digital versatile disk (DVD), and a flexible disk (FD).

The device management program executed by the device management apparatus 10 and the device control program executed by the device 20 in the embodiment and the modifications may be stored in a computer connected to a network such as the Internet and provided by being downloaded through the network. The device management program executed by the device management apparatus 10 and the device control program executed by the device 20 in the embodiment and the modifications may be provided or delivered through a network such as the Internet. The device management program executed by the device management apparatus 10 and the device control program executed by the device 20 in the embodiment and the modifications may be provided by being preliminarily stored in a ROM, for example.

The device management program executed by the device management apparatus 10 and the device control program executed by the device 20 in the embodiment and the modifications have a module structure that implements the units described above in a computer. In practical hardware, the control device 801 reads out the programs from the external storage device 803 to the storage device 802 and executes the programs, so that the respective units are implemented in the computer.

According to the embodiments, it is possible to provide an advantage of reducing a cost for generating the device setting content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management apparatus, comprising:
a device information acquisition unit configured to acquire pieces of region information and pieces of model information from a plurality of devices, respectively, each piece of region information indicating information about a region where the corresponding device is present, each piece of model information indicating a model representing a type of the corresponding device;
a first information generating unit configured to generate first information associating the region indicated by the each piece of region information with the model present in the region; and
a third information generating unit configured to generate third information associating the models included in the first information with device setting contents, respectively, by referring to second information, each of the device setting contents being defined by the second information and being determined in accordance with at least one of the region where the model corresponding to the each of the device setting contents is present and another model present in the region.

2. The device management apparatus according to claim 1, wherein
the device information acquisition unit is configured to further acquire pieces of security information from the devices, respectively, each piece of security information indicating a level of security of the corresponding device,
the first information generating unit is configured to generate, as the first information, information associating the model present in the region indicated by each piece of region information with the level of the security of the model, and
the second information defines each of the device setting contents that is determined in accordance with at least one of the region where the corresponding model is present, the another model present in the region, and the level of the security of the another model.

3. The device management apparatus according to claim 1, wherein
the devices are provided with storage devices, respectively,
a piece of writer identifying information is written to each storage device by a writer identified by the piece of writer identifying information, the writer being fixedly provided in a region where the corresponding device provided with the each storage device is present, and
the device information acquisition unit is configured to acquire, as the pieces of region information, the pieces of writer identifying information written from the devices, respectively.

4. The device management apparatus according to claim 3, further comprising a writer information acquisition unit configured to acquire pieces of region identifying information and pieces of writer identifying information identifying from the writers, respectively, each piece of region identifying information identifying the region where the corresponding writer is present, each piece of writer identifying information identifying the writer, wherein
the first information generating unit is configured to use, as the region indicated by each piece of region information, the region identified by the piece of region identifying information, and the piece of writer identifying information.

5. The device management apparatus according to claim 1, further comprising a second information storage unit configured to store therein the second information.

6. A device management system, comprising:
a device information acquisition unit configured to acquire pieces of region information and pieces of model information from a plurality of devices, respectively, each piece of region information indicating information about a region where the corresponding device is present, each piece of model information indicating a model representing a type of the corresponding device;
a first information generating unit configured to generate first information associating the region indicated by the each piece of region information with the model present in the region;
a second information storage unit configured to store therein second information defining each of the device setting contents that is determined in accordance with at least one of the region where the model corresponding to the each of the device setting contents is present and another model present in the region; and
a third information generating unit configured to generate third information associating the models included in the first information with the device setting contents, respectively, by referring to the second information.

7. A device management method, comprising:
acquiring pieces of region information and pieces of model information from a plurality of devices, respectively, each piece of region information indicating information about a region where the corresponding device is present, each piece of model information indicating a model representing a type of the corresponding device;
generating first information associating the region indicated by the each piece of region information with the model present in the region; and
generating third information associating the models included in the first information with device setting contents, respectively, by referring to second information, each of the device setting contents being defined by the second information and being determined in accordance with at least one of the region where the model corresponding to the each of the device setting contents is present and another model present in the region.
